(19) United States
(12) Patent Application Publication
(10) Pub. No.: US 2002/0075490 A1
(43) Pub. Date: Jun. 20, 2002

(54) System and method for addressable light-directed microarray printing

(75) Inventor: John C. Chappell, Elk Grove, CA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(73) Assignee: Affymetrix, Inc., Santa Clara, CA

(21) Appl. No.: 09/683,374

(22) Filed: Dec. 19, 2001

Related U.S. Application Data
(60) Provisional application No. 60/257,348, filed on Dec. 20, 2000.

(51) Int. Cl. G06F 15/00; G06K 1/00

(52) U.S. Cl. 358/1.8

(57) ABSTRACT

Systems and methods are described for synthesizing probe arrays of polymers. In one such system, a network server processes customer orders to provide data indicative of at least one probe array sequence desired by the customer to be included in a synthesized probe array. A probe array design and control computer executes a probe array design application that processes the probe and array configuration data to provide probe array design data that is then processed by a manufacturing control application to provide gating data. A probe array manufacturing apparatus selectively switches optical transfer elements between substantially light-passing and substantially light-not-passing states in response to the gating data. Light from those optical transfer elements in the light-passing states strikes one or more biological probe array substrates, thereby enabling selective addition of monomers, such as nucleotides, amino acids or saccharides, to the substrate.

### CROSS REFERENCE TO RELATED APPLICATIONS

The present application claims priority from U.S. Provisional Patent Application Serial No. 60/257,348, entitled Addressable UV-Matrix Printing, filed Dec. 20, 2000, hereby incorporated herein by reference in its entirety for all purposes.

### BACKGROUND OF INVENTION

1. Field of the Invention

The present invention is related to systems, methods, and products for synthesizing probes of biological materials on a substrate, and to electronic commerce related thereto.

2. Related Art

U.S. Pat. No. 5,424,186 to Fodor, et al., describes a technique for, among other things, forming and using high density arrays of probes comprising molecules such as oligonucleotide, RNA, peptides, polysaccharides, and other materials. Arrays of oligonucleotides or peptides, for example, are formed on the surface by sequentially removing a photo-removable group from a surface, coupling a monomer to the exposed region of the surface, and repeating the process. Nucleic acid probe arrays synthesized in this manner, such as Affymetrix® GeneChip® probe arrays from Affymetrix, Inc. of Santa Clara, Calif. have been used to generate unprecedented amounts of information about biological systems. Analysis of these data may lead to the development of new drugs and new diagnostic tools.

A typical step in the process of synthesizing these probe arrays is to design a mask that will define the locations on a substrate that are exposed to light. Some systems and methods useful in the design and/or use of such masks are described in the following U.S. Pat. Nos. 5,571,639 to Hubbell, et al.; 5,593,839 to Hubbell, et al.; 5,856,101 to Hubbell, et al.; 6,153,743 to Hubbell, et al.; and 6,188,783 to Balaban, et al., each of which is hereby incorporated herein by reference for all purposes. Notwithstanding the advances described in these patents, it is desirable to identify additional techniques for manufacturing of probe arrays.

### SUMMARY OF INVENTION

Systems, methods, and computer program products, as well as probe arrays produced thereby, are described with reference to illustrative, non-limiting, embodiments. Various implementations are possible, for example, with respect to various types of probe arrays. Moreover, possible implementations are not limited to probe arrays. That is, the synthesized polymers need not be used as probes but may be employed with respect to any of a variety of conventional combinatorial chemistry purposes and uses and others that may be developed in the future.

In accordance with some embodiments, a method is described for synthesizing a nucleic acid probe array. The method includes providing a substrate, providing nucleotides or nucleosides that are protected by a photo-protecting group, directing a light beam onto optical transfer elements, selectively switching the optical transfer elements between substantially light-passing and substantially light-not-passing states in response to gating data, disposing light passed through optical transfer elements in the substantially light-passing state onto the substrate to provide a reactive group, and contacting the nucleotides or nucleosides with the reactive group.

In some implementations, light passed through at least one optical transfer element in the substantially light-passing state strikes a first set of selected portions of the substrate, thereby activating the first set of selected portions. The light beam may include ultra-violet light.

A method also is described for synthesizing one or more arrays of biological probes on one or more substrates. The method includes (1) directing a light beam onto one or more optical transfer elements; (2) selectively switching the optical transfer elements between substantially light-passing and substantially light-not-passing states in response to gating data; and (3) disposing light passed through optical transfer elements in the substantially light-passing state onto the one or more substrates. As used in this context, the term “substantially light-passing” is intended to mean that most of the light is enabled to pass through the optical element (as one non-limiting example, more than 90 percent passes through), in contrast to the “substantially light-not-passing” state in which most of the light is not able to pass through the optical element (as one non-limiting example, more than 95 percent does not pass through), or none of the light passes through. In some implementations, these two states may be distinguished on the basis that the amount of light passed through an optical element for a period of time when a gate is in the “substantially light-passing” state is sufficient to remove photo-removable protective groups, whereas the amount of light (if any) passed through an optical element for a period of time when a gate is in the “substantially light-not-passing” state is not sufficient to remove photo-removable protective groups, all in accordance with any of a variety of known chemistries or ones that may be developed in the future. Thus, in some implementations, the method may further include the step of (4) activating selected portions of the substrate responsive to step (3). In various of these implementations, light passed through at least one optical transfer element in the substantially light-passing state strikes a first set of selected portions of the substrate, thereby activating the first set of selected portions. A further step in these implementations may include (5) providing linker molecules on the substrate, wherein the linker molecules include a reactive functional group protected with a photo-removable protective group, and wherein step (4) includes exposing the photo-removable protective groups to light in the first set of selected portions of the substrate, thereby removing the photo-removable protective groups from the linker molecules and exposing the reactive functional groups in the first set of selected portions. Yet another step may be (6) contacting the exposed reactive functional groups with first monomers capable of reacting with the exposed reactive functional groups. These monomers may include one or more, as non-limiting examples, nucleotides or nucleosides, amino acids or saccharides. The first monomers may include a reactive functional group protected with a photo-removable protective group. Light passed through at least one optical transfer element in the substantially light-passing state may strike a second set of selected portions of the substrate, which may be the same as or different than the first set of selected portions, thereby activating the second set of selected portions. In some implementations, the method may also include (7) contacting exposed reactive functional groups of the linker molecules or of the first monomers with a second monomer, which may be the same or different than the first monomer, capable of reacting with exposed reactive functional groups of the linker molecules or of the first monomer and having a reactive functional group protected with a photo-removable protective group. In accordance with alternative chemistries, step (4) above may alternatively be directed to deactivating selected portions of the substrate responsive to step (3). In accordance with those alternative chemistries, light passed through at least one optical transfer element in the substantially light-passing state strikes a portion of the substrate, thereby deactivating the selected portion.

In accordance with other embodiments, an apparatus is described that includes optical transfer elements; a light beam source that provides a light beam to the optical transfer elements; gates that selectively switch the optical transfer elements between substantially light-passing and substantially light-not-passing states; and one or more biological probe array substrates disposed to be capable of receiving light passed through the optical transfer elements in the substantially light-passing states. The light beam source may include an ultra-violet radiation source. Also, the light beam source may include an integrated parabolic or ellipsoidal high intensity radiation source. In some implementations, the light beam source provides a collimated or Lambertian light beam. As is known to those of ordinary skill in the relevant art, Lambertian reflectance refers to an angularly isotropic reflected radiance field. The light beam source may include a filter capable of selectively passing light having a wavelength of approximately 365 nanometers. The word “approximately” in this context is intended to mean that the bandwidth and distribution of wavelengths of light around the stated wavelength that are allowed to pass through the filter are typical for commercially available filters used with similar light sources. For example, the filter may pass light with wavelengths between 350 to 450 nanometers. More generally, the light passed through the filter should be within the ultra-violent portion of the light spectrum. The light beam source may also include one or more lenses, mirrors, and/or optical integrators constructed and arranged to direct, focus, or collimate the light beam; one or more shutters to control exposure time (i.e., time that light passes through the optical transfer elements and optical gates to the substrate during light-exposure steps in the synthesis process); and/or other conventional optical elements.

The optical transfer elements in these and other embodiments may include a single optical fiber, one or more segments of single optical fibers, a bundle of optical fibers, or one or more segments of bundles of optical fibers. For example, an optical gate may be situated before or after a single optical fiber or bundle of fibers to switch light entering the fibers or switch light exiting the fibers. As another example, a first segment of a fiber or bundle may receive light and pass it through to an optical gate, which may then either allow or prevent light from entering a second segment of a fiber or bundle that, for example, directs the light toward a substrate. Also, the gate may itself comprise all or part of the optical transfer element in particular implementations. For example, light may pass directly from the light source to the optical gate and/or, if the gate is in a substantially light-passing state, the light may pass directly to the substrate. In many embodiments, however, a fiber or bundle of fibers directs the light to and from the optical gate. In some implementations, the optical transfer elements include a tapered portion. For example, the end of an optical transfer element disposed to receive light from the light source (and/or the optical gate in a substantially light-passing state) may be relatively large so as to capture as large a percentage of the light as possible, whereas the end disposed to provide light to the optical gate (and/or to the substrate) may be relatively small in relation to the large end so that many such ends of optical transfer elements may be grouped tightly together for high-resolution activation of the substrate.

The word “gate” is used herein to refer to an optical element that may be selectively switched between substantially light-passing and substantially light-not-passing states. In various implementations, gates in the substantially light-not-passing state refract, reflect (e.g., by total internal reflection), diffract, diffuse, steer, filter, switch, re-direct, and/or block light. Typically, the gates are addressable. In particular preferred implementations, the gates include holographic optical elements. These gates may include a volume phase hologram, an electronically switchable Bragg grating, or other optical switching elements now known or that may be developed in the future.

In some preferred implementations, the apparatus of the preceding and other embodiments includes an interface that aligns ends of the optical transfer elements with the substrate. This alignment enables light gated through the elements to strike precisely determined portions of the substrate and thus enable high-resolution, selective, activation of the substrate. The interface may include a grate having openings that receive the ends. These openings may have tapered portions. For example, a grating may have wells that have tops that are relatively large in relation to the other portions of the wells. This arrangement may facilitate the introduction of the ends of optical transfer elements into the wells.

In various implementations, the apparatus also includes a flow cell that receives reagents and disposes the reagents so that they make contact with the substrate. In preferred aspects of these implementations, the substrate is disposed entirely within the flow cell and the flow cell includes a transparent portion constructed and arranged to enable light to reach the substrate. An advantage of these aspects is that the optical elements, or the grating, typically need only be aligned with the substrate once even though the process of synthesizing polymers based on sequential application of monomers includes switching the optical elements in steps and adding selected monomers for each step (as well as typically adding washing, staining, or other reagents during various additional steps). The need for alignments for each step typically is avoided because the physical relation between the optical elements and the substrate within the flow cell does not change during the various synthesizing steps.

In accordance with other embodiments, an apparatus is described that has a light beam source that provides a light beam. Also included in the apparatus are optical fibers or optical fiber bundles, each comprising a first segment having first and second ends and a second segment having first and second ends, wherein the first ends of the first segments are disposed to receive at least portions of the light beam provided by the light beam source and to pass the portions through to the second ends of the first segments. Addressable gates are also included that selectively switch between substantially light-passing and substantially light-not-passing states, wherein the second ends of the first segments are optically coupled to gate inputs and the first ends of the second segments are optically coupled to gate outputs. Also included in the apparatus are one or more biological probe array substrates disposed to be capable of receiving light passed from the first ends of the second segments to the second ends of the second segments when the addressable gates are in the light-passing state.

In accordance with yet a further embodiment, a system is described that includes a computer having a processor, and a memory unit having stored therein a manufacturing control application that provides gating data. An apparatus, coupled to the computer, includes a plurality of optical transfer elements, a light beam source that provides a light beam to the optical transfer elements, gates that selectively switch the optical transfer elements between substantially light-passing and substantially light-not-passing states in response to the gating data, and one or more biological probe array substrates disposed to be capable of receiving light from the optical transfer elements. The light beam source may be an ultra-violet radiation source.

A system in accordance with another embodiment includes a first computer that processes customer orders for synthesized probe arrays and provides probe and array configuration data indicative of at least one probe array sequence. Also included in the system is a second computer having a processor and a memory unit. Stored in the memory unit is a probe array design application that, when executed by the processor, processes the probe and array configuration data to provide probe array design data. Also stored in the memory unit (or the memory unit of another computer in alternative implementations) is a manufacturing control application that, when executed by the processor, processes the probe array design data to provide gating data. An apparatus coupled to the computer includes a plurality of optical transfer elements, a light beam source that provides a light beam to the optical transfer elements, gates that selectively switch the optical transfer elements between substantially light-passing and substantially light-not-passing states in response to the gating data, and biological probe array substrates disposed to be capable of receiving light from the optical transfer elements. The first computer may receive customer orders over the Internet, and/or any other network.

In accordance with yet a further embodiment, a method is described that includes the steps of (1) processing customer orders for synthesized probe arrays to provide probe and array configuration data indicative of at least one probe array sequence; (2) processing the probe and array configuration data to provide probe array design data; (3) processing the probe array design data to provide gating data; (4) directing a light beam into a plurality of optical transfer elements; (5) selectively switching the optical transfer elements between substantially light-passing and substantially light-not-passing states in response to the gating data; and (6) disposing light passed through optical transfer elements in the substantially light-passing state onto the one or more substrates.

Described in accordance with a further embodiment are arrays of biological probes disposed on substrates, wherein the arrays are synthesized by a method comprising the steps of: (1) directing a light beam to a plurality of optical elements (e.g., optical transfer elements and/or optical gates); (2) selectively switching the optical elements (i.e., by switching the optical gates) between substantially light-passing and substantially light-not-passing states in response to gating data; and (3) disposing light passed through optical elements in the substantially light-passing state onto the one or more substrates. In some implementations, other steps by which the arrays are synthesized include (4) processing customer orders for synthesized probe arrays to provide probe and array configuration data indicative of at least one probe array sequence;(5) processing the probe and array configuration data to provide probe array design data; and (6) processing the probe array design data to provide the gating data.

The preceding embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to others. Also, any one or more function, step, operation, or technique described elsewhere in this specification may, in alternative embodiments or implementations, be combined with any one or more function, step, operation, or technique described in the summary. Thus, the above embodiments and implementations are illustrative rather than limiting.

### BRIEF DESCRIPTION OF DRAWINGS

The above and other embodiments and implementations will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 120 appears first in FIG. 1). In functional block diagrams, rectangles generally indicate functional elements and parallelograms generally indicate data. In method flow charts, rectangles generally indicate method steps and diamond shapes generally indicate decision elements. All of these conventions, however, are intended to be typical or illustrative, rather than limiting.

FIG. 1 is a simplified graphical representation of one embodiment of a probe array manufacturing system connected to users via networks.

FIG. 2 is a functional block diagram of one embodiment of a probe array design and control computer of the probe array manufacturing system of FIG. 1.

FIG. 3 is a functional block diagram of one embodiment of a probe array manufacturing apparatus of the probe array manufacturing system of FIG. 1.

FIG. 4A is a simplified side-view of a preferred implementation of the probe array manufacturing apparatus of FIG. 3.

FIG. 4B is a planar view of cross section 4B, as indicated in FIG. 4A, showing cross sections of illustrative embodiments of optical transfer elements comprising optical fibers or bundles as they enter an illustrative embodiment of a grated interface.

FIG. 4C is a simplified representation of a cross section of a preferred implementation of an addressable optical gate such as may be included in the probe array manufacturing apparatus of FIG. 4A.

FIG. 5A is a cross-sectional side view of a particular implementation of selected components of the probe array manufacturing apparatus of FIG. 3 including tapered optical fibers or bundles, tapered receiving wells in a grated interface, and a wafer microarray substrate.

FIG. 5B is a planar view of the top surface of the microarray substrate of FIG. 5A showing probe features synthesized by the probe array manufacturing apparatus of FIG. 3.

FIG. 6 is a simplified flow diagram of one embodiment of a method for synthesizing catalog probe arrays or for synthesizing custom probe arrays in response to customer orders.

### DETAILED DESCRIPTION

Reference will now be made in detail to some preferred embodiments of the invention. While the invention will be described in conjunction with certain preferred embodiments, it will be understood that these illustrative embodiments are not intended to limit the invention. On the contrary, the invention is intended to cover alternatives, modifications and equivalents that may be included within the spirit and scope of the invention. All cited references, including patent and non-patent literature, are incorporated herein by reference in their entireties for all purposes.

Detailed descriptions are now provided with respect to illustrative systems and methods for synthesizing chemical compounds on a support (such as a probe array of polymers) and probe arrays produced thereby. In one such system, a network server processes customer orders to provide data indicative of at least one probe array sequence desired by the customer to be included in a synthesized probe array. A probe array design and control computer executes a probe array design application that processes the probe and array configuration data to provide probe array design data that is then processed by a manufacturing control application to provide sequential gating data. A probe array manufacturing apparatus selectively switches optical transfer elements between substantially light-passing and substantially light-not-passing states in response to the sequential gating data. Light from those optical transfer elements in the light-passing states strikes one or more biological probe array substrates, thereby enabling selective addition of monomers, such as nucleotides, amino acids or saccharides, to the substrate.

Various techniques and technologies may be used for synthesizing dense arrays of biological materials on or in a substrate or support. For example, Affymetrix ® GeneChip® arrays are synthesized in accordance with techniques sometimes referred to as VLSIPS™ (Very Large Scale Immobilized Polymer Synthesis) technologies. These technologies use chemistries that may be applicable to implementations of the present invention, but typically use photolithographic masks for selectively illuminating portions of a substrate rather than the mask-less approach described herein. Some aspects of VLSIPS™ and other microarray manufacturing technologies are described in U.S. Pat. Nos. 5,424,186; 5,143,854; 5,445,934; 5,744,305; 5,831,070; 5,837,832; 6,022,963; 6,083,697; 6,291,183; 6,309,831; and 6,310,189, all of which are hereby incorporated by reference in their entireties for all purposes. The probes of these arrays in some implementations consist of nucleic acids that are synthesized by methods including the steps of activating regions of a substrate and then contacting the substrate with a selected monomer solution. As used herein, nucleic acids may include any polymer or oligomer of nucleosides or nucleotides (polynucleotides or oligonucleotides) that include pyrimidine and/or purine bases, preferably cytosine, thymine, and uracil, and adenine and guanine, respectively. Nucleic acids may include any deoxyribonucleotide, ribonucleotide, and/or peptide nucleic acid component, and/or any chemical variants thereof such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states. Probes of other biological materials, such as peptides or polysaccharides as non-limiting examples, may also be formed. For more details, see U.S. Pat. No. 6,156,501, which is hereby incorporated by reference herein in its entirety for all purposes.

In conventional implementations of the VLSIPS technologies, regions are activated with a light source shown through a mask in a manner similar to photolithography techniques used in the fabrication of integrated circuits. Other regions of the substrate remain inactive because the mask blocks them from illumination. By repeatedly activating different sets of regions and contacting different monomer solutions with the substrate, a diverse array of polymers is produced on the substrate in accordance with the VLSIPS technologies. Various other steps, such as washing unreacted monomer solution from the substrate, are employed in various implementations of these methods. More specifically, in accordance with certain preferred techniques, linker molecules are provided on a substrate. A terminal end of the linker molecules is provided with a reactive functional group protected with a photo-removable protective group. Using lithographic methods (unlike the current invention in which masks are not required), the photo-removable protective group is exposed to light and removed from the linker molecules in first selected regions. The substrate is then washed or otherwise contacted with a first monomer that reacts with exposed functional groups on the linker molecules. In one of many possible embodiments, the monomer is an amino acid containing a photo-removable protective group at its amino or carboxy terminus and the linker molecule terminates in an amino or carboxy acid group bearing a photo-removable protective group. A second set of selected regions is thereafter exposed to light and the photo-removable protective group on the linker molecule/protected amino acid is removed at the second set of regions. The substrate is then contacted with a second monomer containing a photo-removable protective group for reaction with exposed functional groups. This process is repeated to selectively apply monomers until polymers of a desired length and desired chemical sequence are obtained. Photolabile groups are then optionally removed and the sequence is, thereafter, optionally capped. Side chain protective groups, if present, may also be removed.

A system and method for efficiently synthesizing probe arrays using masks is described in U.S. patent application, Ser. No. 09/824,931, filed Apr. 3, 2001, that is hereby incorporated by reference herein in its entirety for all purposes. A system and method for a rapid and flexible microarray manufacturing and online ordering system is described in U.S. Provisional Patent Application, Serial No. 60/265,103, filed Jan. 29, 2001, that also is hereby incorporated herein by reference in its entirety for all purposes. Systems and methods for optical photolithography without masks are described in U.S. Pat. No. 6,271,957 to Quate and Stern, which is hereby incorporated by reference herein in its entirety for all purposes.

The probes of synthesized probe arrays typically are used in conjunction with biological target molecules of interest, such as cells, proteins, genes or EST's, other DNA sequences, or other biological elements. More specifically, the biological molecule of interest may be a ligand, receptor, peptide, nucleic acid (oligonucleotide or polynucleotide of RNA or DNA), or any other of the biological molecules listed in U.S. Patent No. 5,445,934 (incorporated by reference above) at column 5, line 66 to column 7, line 51. For example, if transcripts of genes are the interest of an experiment, the target molecules would be the transcripts. Other examples include protein fragments, small molecules, etc. Target nucleic acid refers to a nucleic acid (often derived from a biological sample) of interest. Frequently, a target molecule is detected using one or more probes. As used herein, a probe is a molecule for detecting a target molecule. A probe may be any of the molecules in the same classes as the target referred to above. As non-limiting examples, a probe may refer to a nucleic acid, such as an oligonucleotide, capable of binding to a target nucleic acid of complementary sequence through one or more types of chemical bonds, usually through complementary base pairing, usually through hydrogen bond formation. As noted above, a probe may include natural (i.e. A, G, U, C, or T) or modified bases (7-deazaguanosine, inosine, etc.). In addition, the bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages. Other examples of probes include antibodies used to detect peptides or other molecules, any ligands for detecting its binding partners. When referring to targets or probes as nucleic acids, it should be understood that these are illustrative embodiments that are not to limit the invention in any way.

The samples or target molecules of interest (hereafter, simply targets) are processed so that, typically, they are spatially associated with certain probes in the probe array. For example, one or more tagged targets are distributed over the probe array. Some targets hybridize with probes and remain at the probe locations, while non-hybridized targets are washed away. These hybridized targets, with their tags or labels, are thus spatially associated with the probes. The hybridized probe and target may sometimes be referred to as a probe-target pair. Detection of these pairs can serve a variety of purposes, such as to determine whether a target nucleic acid has a nucleotide sequence identical to or different from a specific reference sequence. See, for example, U.S. Pat. No. 5,837,832, referred to and incorporated above. Other uses include gene expression monitoring and evaluation (see, e.g., U.S. Pat. No. 5,800,992 to Fodor, et al.; U.S. Pat. No. 6,040,138 to Lockhart, et al.; and International App. No. PCT/US98/15151, published as WO99/05323, to Balaban, et al.), genotyping (U.S. Pat. No. 5,856,092 to Dale, et al.), or other detection of nucleic acids. The ″992, ″138, and ″092 patents, and publication W099/05323, are incorporated by reference herein in their entireties for all purposes.

Probes typically are able to detect the expression of corresponding genes or EST's by detecting the presence or abundance of mRNA transcripts present in the target. This detection may, in turn, be accomplished by detecting labeled cRNA that is derived from cDNA derived from the mRNA in the target. In general, a group of probes, sometimes referred to as a probe set, contains sub-sequences in unique regions of the transcripts and does not correspond to a full gene sequence. Further details regarding the design and use of probes are provided in U.S. Pat. No. 6,188,783; in PCT Application Serial No. PCT/US 01/02316, filed Jan. 24, 2001; and in U.S. patent applications Ser. No. 09/721,042, filed on Nov. 21, 2000, Ser. No. 09/718,295, filed on Nov. 21, 2000, Ser. No. 09/745,965, filed on Dec. 21, 2000, and Ser. No. 09/764,324, filed on Jan. 16, 2001, all of which patents and patent applications are hereby incorporated herein by reference in their entireties for all purposes.

Labeled targets in hybridized probe arrays may be detected using various commercial devices, sometimes referred to as scanners. Scanners image the targets detecting fluorescent or other emissions from the labels, or by detecting transmitted, reflected, or scattered radiation. A typical scheme employs optical and other elements to provide excitation light and to selectively collect the emissions. Also generally included are various light-detector systems employing photodiodes, charge-coupled devices, photomultiplier tubes, or similar devices to register the collected emissions. For example, a scanning system for use with a fluorescent label is described in U.S. Pat. No. 5,143,854, incorporated by reference above. Other scanners or scanning systems are described in U.S. Pat. Nos. 5,578,832; 5,631,734; 5,834,758; 5,936,324; 5,981,956; 6,025,601; 6,141,096; 6,185,030; and 6,201,639; in PCT Application PCT/US99/06097 (published as W099/47964); and in U.S. Pat. Applications, Ser. Nos. 09/682,837 filed Oct. 23, 2001, 09/683,216 filed Dec. 3, 2001, and 09/683,217 filed Dec. 3, 2001, 09/683,219 filed Dec. 3, 2001, each of which patent and patent application is hereby incorporated by reference in its entirety for all purposes.

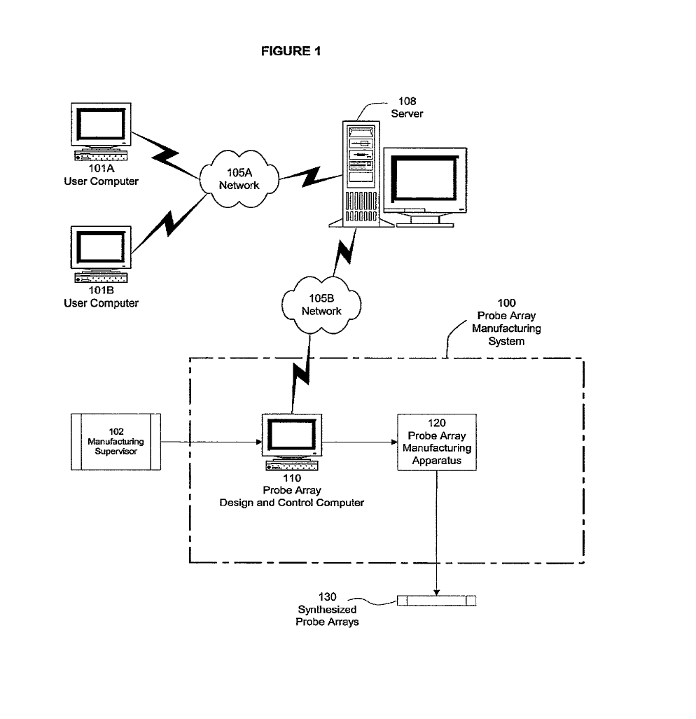

FIG. 1 is a simplified graphical representation of one embodiment of a probe array manufacturing system 100 connected to users via networks. Illustrative system 100 includes a probe array design and control computer 110 and a probe array manufacturing apparatus 120 that cooperate in the manufacture of synthesized probe arrays 130. In this illustrative implementation, users may access system 100 via user computers 101 (represented in this example by computers 101A and 101B) and network 105A, which may be a local-area, wide-area, or any other network, including an intranet or the Internet. In a typical network implementation, server 108 receives requests, commands, and/or other information from user computers 101 and forwards them via network 105B to probe array design and control computer 110 for processing. Network 105B also may be any type of network. Similarly, information from computer 110 may be sent via network 105B for processing and routing by server 108 to user computers 101. In other implementations, one or more of user computers 101 may be coupled to probe array design and control computer 110 by a local network, or a user may access computer 110 directly. In the illustrated implementation, manufacturing supervisor 102 also has local access to computer 110, although this access may be gained via a network in other implementations. Further illustrative network configurations and components suitable for communications between users and probe array design and control computer 110 are described in PCT Application Serial No. PCT/US 01/02316, filed Jan. 24, 2001, incorporated herein by reference above. As will be evident to those of ordinary skill in the relevant art, various other network configurations are possible and many typical components of network configurations are not shown in FIG. 1 for sake of clarity of illustration.

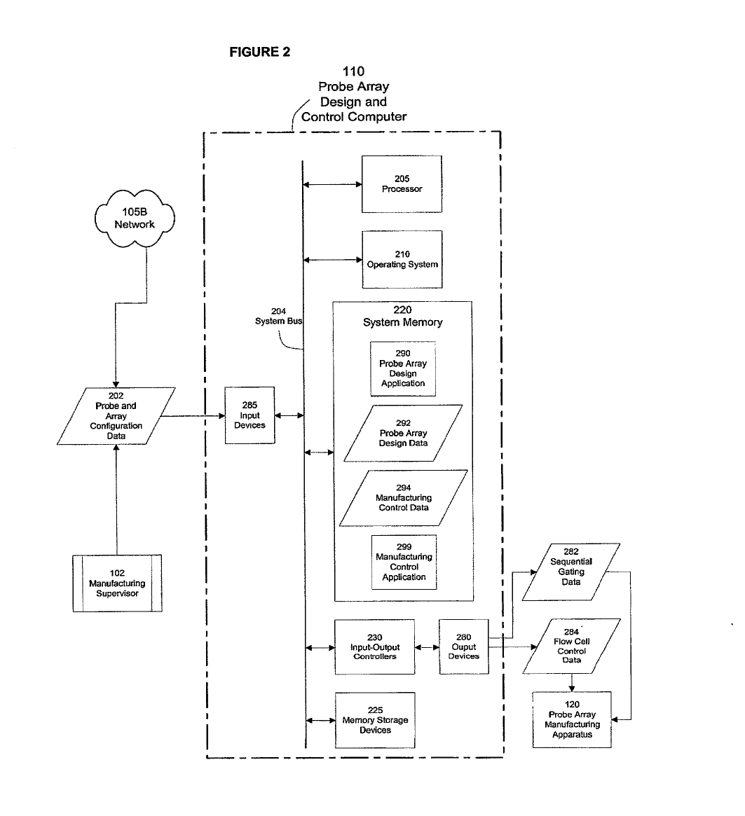

FIG. 2 is a functional block diagram of an illustrative implementation of probe array design and control computer 110. Computer 110 may be a personal computer, a workstation, a server, or any other type of computing platform now available or that may be developed in the future. In the illustrated embodiment, computer 110 may be located locally to probe array manufacturing apparatus 120 as illustratively shown in FIG. 1, or it may be coupled to apparatus 120 over a local-area, wide-area, or other network, including an intranet and/or the Internet. Computer 110 includes known components such as processor (CPU) 205, operating system 210, system memory 220, memory storage devices 225, and input-output controllers 230, all of which typically communicate in accordance with known techniques such as via system bus 204. System memory 220 may be any of a variety of known or future memory storage devices. Examples include any commonly available random access memory (RAM), magnetic medium such as a resident hard disk or tape, an optical medium such as a read and write compact disc, or other memory storage device. Memory storage devices 225 may be any of a variety of known or future devices, including a compact disk drive, a tape drive, a removable or internal hard disk drive, or a diskette drive. Such types of memory storage devices 225 typically read from, and/or write to, a program storage medium (not shown) such as, respectively, a compact disk, magnetic tape, removable or internal hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage medium used in conjunction with memory storage devices 225. A variety of other components may be included in computer 110, as is well known by those of ordinary skill in the relevant art.

In one illustrative implementation, a user may provide information regarding the probes that are to be synthesized on probe arrays 130. Numerous conventional techniques may be employed to facilitate a user's selection or specification of probe information, such as by selecting from menus, lists, catalogs, or various other graphical or other user interfaces. The user-supplied probe information may include, as but one of many possible examples, identifiers (such as accession numbers, or probe-set identifiers) of genes or EST's that should be represented by one or more probes on synthesized probe arrays 130. Other non-limiting examples of user-supplied data include the number of synthesized probe arrays 130 to be produced, a date on which delivery is requested, customer identifying information for billing and tracking purposes, various other information that is typical to the conduct of electronic commerce over the Internet, and other data. User-supplied probe information is illustrated in FIG. 2 as being communicated via network 105B and included in probe and array configuration data 202. Manufacturing supervisor 102 may also provide all or aspects of probe and array configuration data 202. For example, rather than using customer-supplied data, supervisor 102 may specify probe-set identifiers or other information that identifies probes to be included in probe arrays 130. Whether or not data 202 includes customer-supplied information, supervisor 102 may also provide information regarding various aspects of production such as periods of time for allowing light to activate a substrate, adjustments to distances between optical elements and a substrate, reagents to be used, alignment parameters, and other data. It will be understood that the term “supervisor” is used for convenience only, and that machines may provide this information or a person who is a production manager or employee, array designer, and so on could also fulfill this role. In this or alternative implementations, any of data 202 may also be stored in computers 101 or 110 and/or server 108. For example, user-supplied information may be stored for future reference in any of these computers so that a user may simply re-activate or amend a previously submitted order rather than repeating the information in a new order.

Probe array design application 290 is a software application or process that uses aspects of data 202 and or other data to design the number of probes employed with respect to each anticipated target, the sequences of monomers to be included in each probe, the locations of the probes on probe arrays 130, the sequences and placement of control probes and other control features, and other probe array characteristics. This output of application 290 is illustratively represented in FIG. 2 as probe array design data 292. Aspects of computer-aided design systems such as may be implemented by application 290 include those described in U.S. Pat. Nos. 5,593,839 and 5,856,101, both of which have been incorporated herein. Some additional considerations, techniques, algorithms, and other factors that may be employed in various implementations of application 290 are described in U.S. Pat. No. 6,188,783; in PCT Application Serial No. PCT/US 01/02316; and/or in U.S. patent applications Ser. Nos. 09/721,042, 09/71 8,295, 09/745,965, and 09/764,324, also incorporated by reference above. Manufacturing control application 299 is a software application or process that uses aspects of data 202 (such as may be provided by supervisor 102), data 292, and or other data to control the process of synthesizing probe arrays 130. The output of application 299 is represented illustratively as manufacturing control data 294. One aspect of data 294 may be, for example, sequential gating data 282 that, in accordance with any of a variety of known techniques, is used to cause addressable optical gates 350 (described below) to be switched between on and off states. Another aspect of data 294 may be, for example, flow cell control data 284 that causes flow cell controller 385 to introduce fluids into, or remove fluids from, flow cell 380, as described below.

Applications 290 or 299 may be written in any of a variety of high-level, or other, programming languages such as C++. As will be evident to those skilled in the relevant art, applications 290 or 299 may be loaded into system memory 220 and/or memory storage devices 225 through an input device of input/output devices 285. Alternatively, applications 290 or 299 may be implemented as executable instructions stored in firmware. Applications 290 and 299 each comprise a set of software instructions that cause functions to be performed as described herein. Application 290 may therefore be referred to as a set of probe array design instructions, and application 299 may therefore be referred to as a set of manufacturing control instructions. Applications 290 and 299 may be included in a single process or application in some implementations, or their functions may be otherwise distributed between them and/or other software applications or processes.

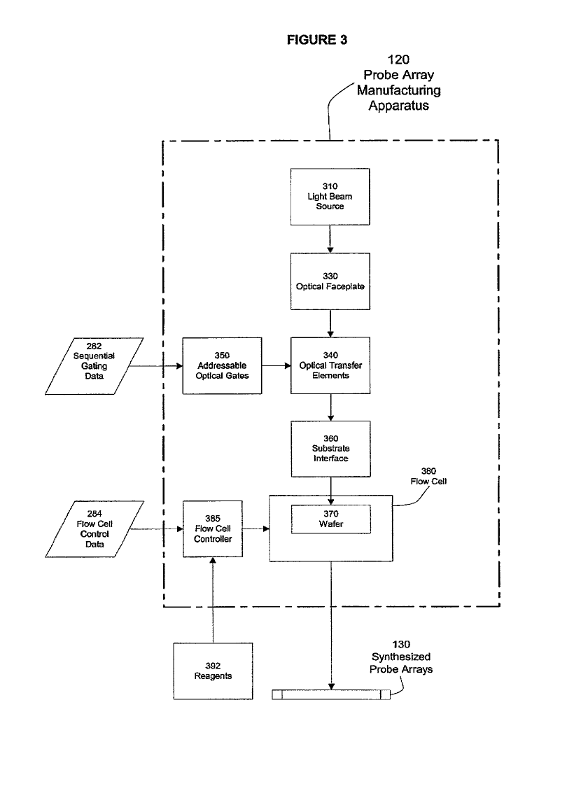

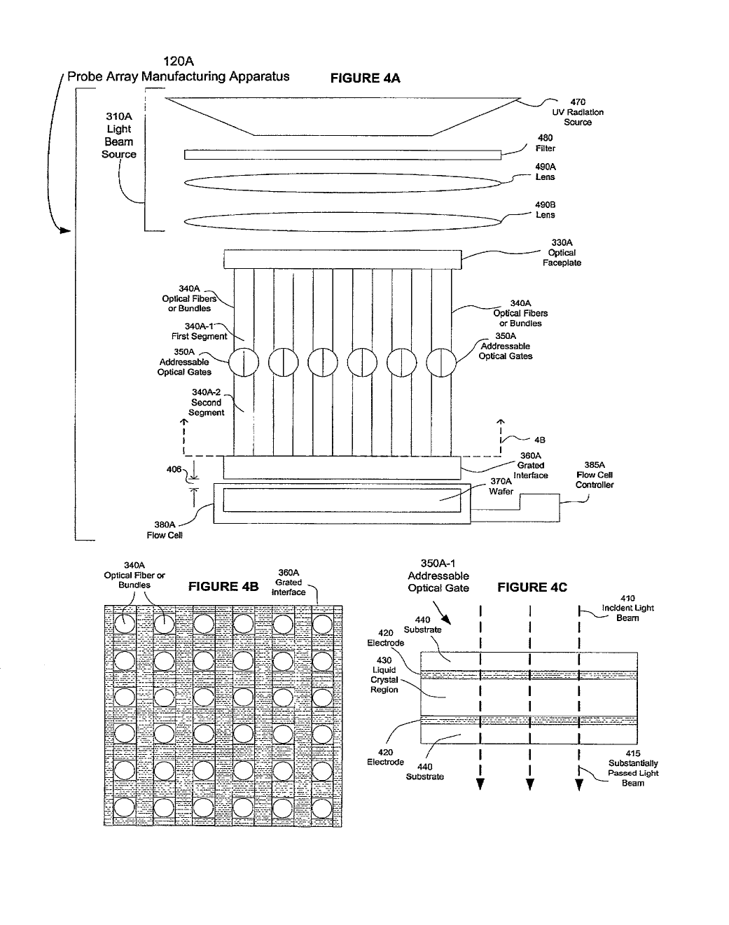

FIG. 3 is a functional block diagram of one non-limiting embodiment of probe array manufacturing apparatus 120. Apparatus 120 of this implementation includes light beam source 310 that provides light for synthesizing probes. In some preferred implementations, such as described in relation to FIG. 4A, source 310 provides ultra-violet light, but the invention is not so limited. That is, light of other wavelengths may be used in alternative implementations. In particular preferred implementations, source 310 may be an integrated parabolic or ellipsoidal high intensity radiation source that provides a collimated light beam. Such devices are available from a variety of vendors, such as AB Manufacturing, Inc., of San Jose, Calif. In such implementations, source 310 may thus include, or be coupled to, one or more lenses, mirrors, and/or other optical elements constructed and arranged to direct, focus, and/or collimate the light beam. Optionally, source 310 may also include, or be coupled with, a filter capable of selectively passing light having a wavelength appropriate for the chemistry used in synthesizing probe arrays, such as approximately 365 nanometers in applications in which ultra-violet light is used. In some implementations, the filter may be selectable under control, for example, of computer 110 and application 299 so that appropriate wavelengths may be used for appropriate synthesizing processes or process steps.

Apparatus 120 also optionally includes optical faceplate 330 that aligns ends of optical transfer elements 340 (described below) with the light beam provided by source 310 and, in the illustrated implementation, provides mechanical support for the elements 340. In some implementations, faceplate 330 has a first surface that receives the light beam and a second surface opposed to the first surface. Faceplate 330 may be, for example, any of a variety of commercially available fiber optic plates that precisely transmit light from its input surface to its output surface. Various implementations of faceplate 330, and of other components of apparatus 120 such as magnifiers, optical transfer elements, and assemblies for these and other components, are available from numerous vendors including, for example, Incom, Inc. of Charlton, Mass. Light from source 310 enters optical transfer elements 340 as the light exits faceplate 330 in the illustrated implementation. In some of various other implementations, light could proceed directly from source 310 to elements 340.

Many arrangements of optical transfer elements 340 are possible. As some non-limiting examples, elements 340 may comprise a single optical fiber, one or more segments of single optical fibers, a bundle of optical fibers, or one or more segments of bundles of optical fibers. For example, one of elements 340 could be a ten-micron-diameter, shielded, cladded, optical fiber, or a bundle of hundreds or thousands of such fibers, such as are available commercially from various vendors including Incom, Inc.; Schott Corporation of Yonkers, N.Y.; and Rolyn Optics Company of Covina, Calif. Numerous other dimensions and shapes are commercially available from these and other vendors, and any one or combination of fibers of these various sizes and/or shapes may be or comprise an element 340. Moreover, bundles of fibers, or bundles of bundles of fibers, are commercially available pre-assembled in configurations suitable for alignment with interfaces such as substrate interface 360, described below. Also, assembled configurations of fibers or bundles or fibers could be used without an interface 360. For example, in some implementations the ends of these configurations could be applied so as to contact directly the surface of wafer 370. The surface of contact could be the same as the surface on which probes are synthesized or, in these or other implementations, light could be shown through a transparent substrate from a side opposite to that on which the probes are synthesized. Photoresist and/or optical coatings may also be employed as described in U.S. Pat. No. 6,307,042 that is hereby incorporated by reference herein in its entirety for all purposes. Other possible arrangements include employing multiple light sources. For example, each fiber or bundle, or any group thereof, could have a separate light source.

In a preferred embodiment, there is one optical transfer element 340 for each probe feature to be synthesized to produce synthesized probe arrays 130. As used in this context, the term “probe feature” refers to one or more probes intended to have a same sequence of monomers and contiguously arranged on the substrate. For example, in a GeneChip® probe array, a probe feature typically includes hundreds of thousands of polymer probes of the same intended monomer sequence arranged in a square, although any shape may be used. Adjacent to that probe feature, another probe feature may be synthesized that includes polymer probes of another sequence. Combinations of these probe features, sometimes referred to as probe sets, may be used to represent a gene or EST, as an illustrative example. Further details regarding the arrangement of probe features in illustrative implementations are provided in U.S. patent application, Ser. No. 09/681,819, hereby incorporated by reference herein in its entirety for all purposes, and in PCT Application Serial No. PCT/US 01/02316; U.S. patent application, Ser. No. 09/824,931; and other patents and patent applications incorporated by reference above.

A reason that it may be advantageous to use one optical transfer element for one probe feature is that all the probes in a probe feature are typically synthesized using the same sequence of light activation. That is, exposure to light of a photo-removable group of one probe typically coincides with the exposure of each of the other probes of the same probe feature, and thus a single optical transfer element may be sufficient to simultaneously illuminate all probes of a probe feature. In some implementations, however, it may be desired to synthesize probe features having dimensions significantly larger than the beam of light provided by a single optical transfer element. In such cases, two or more of optical transfer elements 340 may be switched together (i.e., synchronously in terms of being either in the light-passing or light-passing states) in order that each may synthesize probes in different (or overlapping) areas of a common probe feature. Elements 340 may also be grouped for synchronous switching to a common probe area in order to increase the intensity of light provided to the probe area (e.g., if the elements provide overlapping areas of illumination), to provide redundancy for quality control, or for other reasons.

Also included in the illustrated implementation of apparatus 120 are addressable optical gates 350. Gates 350 are capable of selectively switching each of optical transfer elements 340 between substantially light-passing and substantially light-not-passing states. As noted, the degrees to which gates 350 are required either to pass light or prevent it from passing may depend both on the characteristics of the particular type of gate employed and the tolerances imposed by the chemistry of, for example, removing photo-removable groups. The word “substantially” thus is used in these contexts to indicate that it generally is not necessary, and may not be practicable, that gates 350 absolutely prevent light from passing in their “substantially light-not-passing” states. It generally is sufficient that the different states reliably result in different chemical or other reactions employed in the synthesis of probes. In their substantially light-not-passing state, various implementations of gates 350 may refract, reflect, diffract, diffuse, steer, filter, switch, or block light, or various combinations of these effects may be employed.

There are many possible configurations by which gates 350 may be coupled with, interposed within, interposed between, exposed to, or otherwise arranged with respect to optical transfer elements 340. The implementation described with respect to FIG. 4A is just one example. Moreover, it is possible that the function of elements 340 to direct light from source 310 to a probe array substrate (such as wafer 370 of the illustrated example) may be included within the functions of gates 350 in some implementations. That is, light may directly enter inputs of gates 350 and be directed by outputs of gates 350 directly toward the substrate. Typically, gates 350 are individually addressable so that, for example, application 299 may selectively switch certain ones of gates 350 to the light-passing state while it switches others of gates 350 to the light-not-passing state. One example of a commercially available product that may be used as a gate 350 is the DigiWave™ Application Specific Optical Element made by DigiLens, Inc. of Sunnyvale, Calif. This device comprises a volume phase hologram. As further described in relation to FIG. 4C below, the device includes an electronically switchable Bragg grating in which the Bragg surfaces are populated by micro-droplets of liquid crystal interspersed with region of relatively pure photopolymer. See also the micro-mirror arrays that may be configured to selectively reflect light to a substrate, as described in U.S. Pat. No. 6,271,957, incorporated by reference above.

Apparatus 120 of the illustrated implementation also includes substrate interface 360 that, in some implementations, aligns ends of optical transfer elements 340 with wafer 370. For example, interface 360 may be a grate having openings, like open ended wells for example, that each receive one or more of elements 340. To provide some non-limiting examples, each well may receive a single end of a single one of elements 340 switched by a single gate 350, or a bundle of elements 340 each switched by the same gate 350, in an implementation in which each probe feature corresponds to one well. Alternatively, each well may receive one or more elements 340, and/or one or more bundles of elements 340, each element or bundle switched by a different gate 350 in an implementation in which more than one probe feature corresponds to one well. Various other combinations of inserting ends of elements 340 into openings of interface 360 are possible.

In some implementations in which probe features are to be densely disposed on wafer 370, the wells or other openings of interface 360 may be very small, such as 10 micron squares as one example. Various technologies suitable for very small manufacture may be employed to machine interface 360 to the desired dimensions and tolerances in such implementations. For example, interface 360 may be manufactured as a mold using conventional LIGA (a German-language acronym for Lithography, Electroplating, and Molding) technology employing MicroElectroMechanical Systems (MEMS) micro-machining techniques developed by the Microelectronics Development Laboratory of Sandia National Laboratories of Albuquerque, N.Mex. In addition to aligning elements 340 with portions of wafer 370 as desired, interface 360 may provide mechanical support for elements 340 and other components of apparatus 120. In other implementations, such as in which bundles of elements 340 are pre-configured in precisely aligned and mechanically supported bundles, interface 360 may not be needed for aligning elements 340 with wafer 370, or it may perform a simple mechanical support function or gross alignment/support function.

Also included in apparatus 120 of the illustrated implementation are flow cell controller 385 and flow cell 380. Controller 385 may be any of a variety of devices for controlling liquid flows, particularly in microfluidic devices. A non-limiting example of a flow cell controller is the Affymetrix® Work Cell Controller employed in the manufacture of Affymetrix® GeneChip® probe arrays. One non-limiting example of flow cell 380 is the Modular Oligo Synthesizer also employed in the manufacture of Affymetrix® GeneChip® probe arrays. Examples and descriptions of possible implementations of controller 385 and/or flow cell 380 are provided in U.S. Pat. Nos. 5,143,854; 5,445,934; 5,744,305; 5,831,070; 5,837,832; 6,022,963; 6,083,697; 6,291,183; 6,309,831; and 6,310,189; incorporated above, and by U.S. Pat. Nos. 6,050,719; 6,114,122; 6,132,580; 6,168,948; 6,284,525; 6,287,850; and 6,326,211, each of which is also hereby incorporated by reference herein in its entirety for all purposes.

The illustrative substrate of this example, i.e., wafer 370, may be used to synthesize one or more than one probe array. For example, arrays of probe arrays may be synthesized on wafer 370, or a single array may be synthesized using the entire surface of wafer 370, as non-limiting examples. When arrays or probe arrays are synthesized, the wafer may in some implementations be diced to provide individual arrays for separate packaging. In other implementations, as noted above with respect to GeneChip® arrays, a single probe array may be synthesized on wafer 370 and flow cell 380 may constitute the final cartridge packaging for the probe array. As also noted, wafer 370 in such implementations may advantageously be disposed entirely within flow cell 380. In such implementations, wafer 370 or flow cell 380 typically need only be aligned once with substrate interface 360 since neither interface 360 nor flow cell 380 need be moved to accomplish sequential steps such as light exposure, contact with monomers (such as nucleic acids, amino acids, or saccharides), contact with photo-removable protecting groups, and application of other reagents. When the substrate is disposed entirely within the flow cell, the flow cell typically includes a transparent portion that enables light to reach the substrate during the light exposure steps.

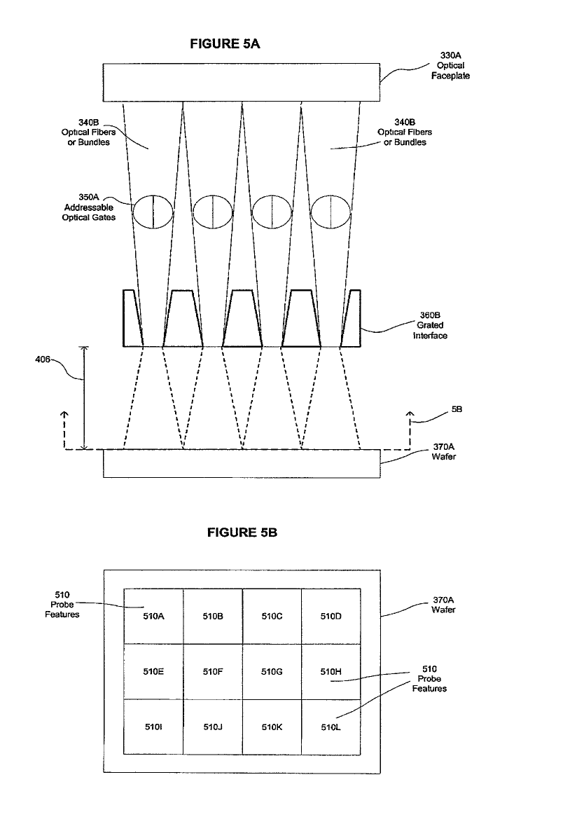

FIG. 4A is a simplified side-view of one preferred and non-limiting implementation of the probe array manufacturing apparatus of FIG. 3. It should be noted that none of FIGS. 4A-4C and 5A-5B are necessarily drawn to scale, and the dimensions of various elements should not necessarily be inferred from their representation in these drawings. Light beam source 310A of the implementation shown in FIG. 4A includes ultra-violet radiation source 470, filter 480, and focusing/collimating lenses 490A and 490B. Optical transfer elements 340 of this example are represented by optical fibers or optical fiber bundles 340A, each of which consists of a first segment 340A-1 and a second segment 340A-2. A first end of the first segment interfaces with optical faceplate 330A to align the fiber or bundle with light exiting the faceplate and also for mechanical stability. Light is transmitted through each of the first segments to a second end of those segments that, in accordance with known techniques, are each optically coupled to the input of one of addressable optical gates 350A. Light either passes through gates 350A, or not, depending on its state. The outputs of gates 350 are optically coupled in accordance with known techniques to first ends of second segments 340A-2. In this implementation, each of the second ends of second segments 340A-2 are inserted into open-ended wells in grated interface 360A so that the bottoms of second segments 340A-2 are substantially in the same plane as the bottom surface of interface 360A. Other alignments and arrangements may be employed in other implementations.

In the implementation of FIG. 4A, wafer 370A is disposed entirely within flow cell 380A, and there is a gap 406 between the bottom surface of interface 360A (and thus of the bottoms of second segments 340A-2 in this example) and the top surface of wafer 370A. For example, gap 406 may be 10-15 microns. Gap 406 enables some spreading of light after it exits from the bottoms of second segments 340A-2, thus allowing illumination of contiguous areas of wafer 370A. FIG. 4B is a planar view of cross section 4B, as indicated in FIG. 4A, showing a cross section of second segments 340A-2 as they enter grated interface 360A. It should be noted again that FIG. 4B is not necessarily drawn to scale and that the interstitial areas of interface 360A typically are much smaller in relation to the well or fiber sizes than are shown for sake of clarity in FIG. 4B. Nonetheless, as may be seen from FIG. 4B, the presence of interstitial support members of interface 360A could, depending on their dimensions, prevent illumination of the entire surface of wafer 370A if the ends of second segments 340A-2 directly abutted the top surface of wafer 370A. However, as noted above, implementations are possible in which a substrate interface 360 is not employed, such as when configured bundles of closely packed fibers, or closely packed bundles of fibers, are employed and potentially disposed directly on or adjacent the substrate surface. In any event, uniform contact between each of second segments 340A-2 and the top surface of wafer 370A could involve taking into account waves or other irregularities in the top surface of wafer 370A.

FIG. 4C is a simplified representation of a cross section of a preferred implementation of one of gates 350, referred to as addressable optical gate 350A-1. Gate 350A-1 is a type of holographic optical element manufactured by DigiLens, Inc., noted above. A liquid crystal region 430 includes micro-droplets. An AC voltage applied to electrodes 420 orients the optical axis of the liquid crystals within the droplets to produce an effective refractive index. When the effective refractive index matches that of other components of region 430, light is substantially passed; when there is no match, light is not substantially passed. In the example shown in FIG. 4C, incident light beam 410 is substantially passed through region 430, and through substrates 440 that enclose the device, to provide substantially passed light beam 415.

FIG. 5A is a cross-sectional side view of a particular implementation of selected components of probe array manufacturing apparatus 120. FIG. 5A shows tapered optical fibers or bundles 340B disposed between optical faceplate 330A and grated interface 360B. Interface 360B in this implementation has tapered wells for receiving the ends of fibers or bundles 340B. As noted, the tapering of fibers or bundles 340B is advantageous in capturing as much of the light exiting faceplate 330A as possible, while still providing small ends at the coupling with interface 360B to enable higher resolution synthesis of probe features. As also noted, tapering of the wells of interface 360B may be advantageous in some implementations in aligning and disposing the ends of fibers or bundles 340B into the wells. Although the tapers of bundles 340B are shown for sake of clarity in FIG. 5A as different than the tapers of the wells of interface 360B, these tapers may advantageously be matched in other implementations to provide greater stability and precision of registration.

FIG. 5B is a planar view of the top surface of wafer 370A as indicated by the cross section line 5B of FIG. 5A. Because a gap 406 is provided between the bottoms of optical fibers or bundles 340B and the top surface of wafer 370A, light disperses sufficiently to enable probe features 510 (shown in FIG. 5B) to be synthesized contiguously over the surface of wafer 370A. Methods for calculating the appropriate dimension of gap 406 in view of the size of features 510, the size of the ends of fiber or bundles 340B, optical characteristics of fiber or bundles 340B, and other factors, will now be evident to those of ordinary skill in the relevant arts in view of this disclosure.

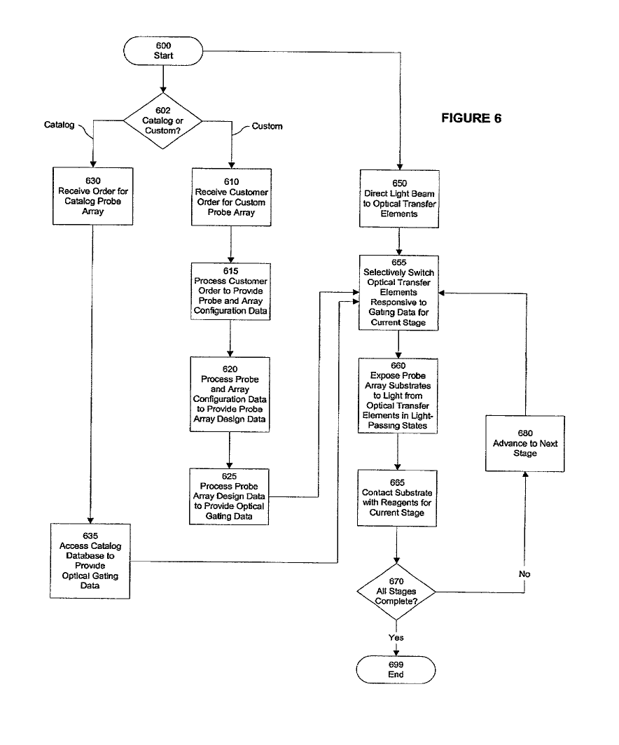

FIG. 6 is a simplified flow diagram of one embodiment of a method for synthesizing catalog probe arrays or for synthesizing custom probe arrays in response to customer orders. If it is desired to synthesize a catalog probe array (see decision element 602), manufacturing supervisor 102 (for example) may initiate the synthesis by providing or retrieving appropriate probe and array configuration data 202. Computer 110 of this example operates upon data 202 to provide sequential gating data 282 (see process element 635) and flow cell control data 284 (not represented in the flow chart for sake of clarity). These data need not be recalculated in some implementations, as they typically need not be changed for repeated synthesis of previously synthesized catalog arrays. Alternatively, a customer may initiate an order for a custom probe array (decision element 602 and process element 610). If this is a repeat order, the appropriate gating data may simply be retrieved from a database rather than recalculated, as described above with respect to the processing of a catalog probe array. Otherwise, the customer order is processed (element 615) by determining appropriate sequences, numbers, locations, and other aspects of probes and control elements (element 620). This probe and array configuration data and probe array design data is processed in computer 110 as described above to generate optical gating data (element 625).

Whichever branch of decision element 602 is taken, optical gating data is thus provided for switching optical transfer elements as appropriate for synthesis of probe features during sequential light-activation steps (elements 650, 655, 660) followed by reagent-application steps (element 665). The group of light-activation steps, reagent-application steps, and related steps that result in the addition of a monomer and preparation for the application of additional monomers may be referred to for sake of illustration as a stage. The groups of steps are generally repeated (element 680) until all the stages are completed (decision element 670); i.e., until the synthesis of all probe features has been completed. In the case of custom arrays, the arrays may be shipped and billed to the customer who ordered them in accordance with conventional electronic commerce techniques and systems. In the case of catalog arrays, the arrays may be similarly shipped to customers who ordered them or stored for later sale.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments. Also, the functions of several elements may, in alternative embodiments, be carried out by fewer, or a single, element. Similarly, in some embodiments, any functional element may perform fewer, or different, operations than those described with respect to the illustrated embodiment. Further, functional elements shown as distinct for purposes of illustration may be incorporated within other functional elements in a particular implementation. Also, the sequencing of functions or portions of functions generally may be altered. Certain functional elements, files, data structures, and so on, may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and local to a server or other computer may be located in a computer system or systems remote from the server or other computer. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

What is claimed is:

1. A method for synthesizing a nucleic acid probe array, comprising the steps of:
(1) providing a substrate;
(2) providing nucleotides or nucleosides that are protected by a photo-protecting group;
(3) directing a light beam onto a plurality of optical transfer elements;
(4) selectively switching the optical transfer elements between substantially light-passing and substantially light-not-passing states in response to gating data;
(5) disposing light passed through optical transfer elements in the substantially light-passing state onto the substrate to provide a reactive group; and
(6) contacting the nucleotides or nucleosides with the reactive group.

2. The method of claim 1, wherein:
light passed through at least one optical transfer element in the substantially light-passing state strikes a first set of selected portions of the substrate,
thereby activating the first set of selected portions.

3. The method of claim 1, wherein:
the light beam includes ultra-violet light.

4. The method of claim 1, wherein:
the optical transfer elements include an optical fiber.

5. A method for synthesizing one or more arrays of biological probes on one or more substrates, comprising the steps of:
(1) directing a light beam onto one or more optical transfer elements;
(2) selectively switching the optical transfer elements between substantially light-passing and substantially light-not-passing states in response to gating data; and
(3) disposing light passed through optical transfer elements in the substantially light-passing state onto the one or more substrates.

6. The method of claim 5, further comprising the step of:
(4) activating selected portions of the substrate responsive to step (3).

7. The method of claim 6, wherein:
light passed through at least one optical transfer element in the substantially light-passing state strikes a first set of selected portions of the substrate,
thereby activating the first set of selected portions.

8. The method of claim 7, further comprising the step of:
(5) providing linker molecules on the substrate, wherein the linker molecules include a reactive functional group protected with a photo-removable protective group; and
wherein step (4) includes exposing the photo-removable protective groups to light in the first set of selected portions of the substrate, thereby removing the photo-removable protective groups from the linker molecules and exposing the reactive functional groups in the first set of selected portions.

9. The method of claim 8, further comprising the step of:
(6) contacting the exposed reactive functional groups with first monomers capable of reacting with the exposed reactive functional groups.

10. The method of claim 9, wherein:
the first monomers include a nucleotide, nucleoside, amino acid, or saccharide.

11. The method of claim 9, wherein:
the first monomers include a reactive functional group protected with a photo-removable protective group.

12. The method of claim 11, wherein:
light passed through at least one optical transfer element in the substantially light-passing state strikes a second set of selected portions of the substrate,
which may be the same as or different than the first set of selected portions,
thereby activating the second set of selected portions; and wherein the method further includes the step of
(7) contacting exposed reactive functional groups of the linker molecules or of the first monomers with a second monomer, which may be the same or different than the first monomer, capable of reacting with exposed reactive functional groups of the linker molecules or of the first monomer and having a reactive functional group protected with a photo-removable protective group.

13. The method of claim 5, further comprising the step of:
(4) deactivating selected portions of the substrate responsive to step (3).

14. The method of claim 13, wherein:
light passed through at least one optical transfer element in the substantially light-passing state strikes a portion of the substrate, thereby deactivating the selected portion.

15. An apparatus, comprising:
a plurality of optical transfer elements;
a light beam source that provides a light beam to the optical transfer elements;
a plurality of gates constructed and arranged to selectively switch the optical transfer elements between substantially light-passing and substantially light-not-passing states; and
one or more biological probe array substrates disposed to be capable of receiving light passed through the optical transfer elements in the substantially light-passing states.

16. The apparatus of claim 15, wherein:
the light beam source includes an ultra-violet radiation source.

17. The apparatus of claim 15, wherein:
the light beam source includes an integrated parabolic or ellipsoidal high intensity radiation source.

18. The apparatus of claim 15, wherein:
the light beam source provides a collimated light beam.

19. The apparatus of claim 15, wherein:
the light beam source includes a filter capable of selectively passing light having a wavelength of approximately 365 nanometers.

20. The apparatus of claim 15, wherein:
the light beam source includes one or more of the group of optical elements consisting of a lens, mirror, shutter, or optical integrator.

21. The apparatus of claim 15, wherein:
the optical transfer elements comprise a single optical fiber, one or more segments of single optical fibers, a bundle of optical fibers, one or more segments of bundles of optical fibers, or one or more optical gates.

22. The apparatus of claim 15, wherein:
one or more of the plurality of optical transfer elements comprises first and second segments, each having an end optically coupled to a gate.

23. The apparatus of claim 15, wherein:
one or more of the plurality of optical transfer elements includes a tapered portion.

24. The apparatus of claim 15, wherein:
the gates include addressable gates.

25. The apparatus of claim 15, wherein:
the gates, in the substantially light-not-passing state, refract, reflect, diffract, diffuse, steer, filter, switch, re-direct, or block light.

26. The apparatus of claim 15, wherein:
one or more of the gates include a holographic optical element.

27. The apparatus of claim 26, wherein:
one or more of the gates include a volume phase hologram.

28. The apparatus of claim 26, wherein:
one or more of the gates include an electronically switchable Bragg grating.

29. The apparatus of claim 15, wherein:
the one or more biological probe array substrates includes a wafer.

30. The apparatus of claim 15, wherein:
the one or more biological probe array substrates includes a plurality of probe array substrates on a single wafer.

31. The apparatus of claim 15, wherein:
the one or more biological probe array substrates includes a plurality of wafers, each having a plurality of probe arrays.

32. The apparatus of claim 15, further comprising:
a first interface that aligns ends of the optical transfer elements with the light beam so that portions of the light beam enter the ends.

33. The apparatus of claim 15, further comprising:
a second interface that aligns ends of the optical transfer elements with the substrate.

34. The apparatus of claim 33, wherein:
the second interface includes a grate having openings that receive the ends.

35. The apparatus of claim 34, wherein:
the openings include tapered portions.

36. The apparatus of claim 34, wherein:
the grate is manufactured using LIGA technology.

37. The apparatus of claim 34, wherein:
the grate is manufactured using polymethylmethacrylate resist technology.

38. The apparatus of claim 15, further comprising:
a flow cell constructed and arranged to receive reagents and to dispose the reagents in relation to the substrate.

39. The apparatus of claim 38, wherein:
the substrate is disposed entirely within the flow cell and the flow cell includes a transparent portion constructed and arranged to enable light to reach the substrate.

40. The apparatus of claim 38, further comprising:
a flow cell controller that selectively provides reagents to the flow cell.

41. The apparatus of claim 40, wherein:
the reagents include nucleic acids, amino acids, or saccharides.

42. An apparatus, comprising:
a light beam source that provides a light beam;
a plurality of optical fibers or optical fiber bundles, each comprising a first segment having first and second ends and a second segment having first and second ends, wherein the first ends of the first segments are disposed to receive at least portions of the light beam provided by the light beam source and to pass the portions through to the second ends of the first segments;
a plurality of addressable gates having inputs and outputs and constructed and arranged to selectively switch between substantially light-passing and substantially light-not-passing states, wherein the second ends of the first segments are optically coupled to the gate inputs and the first ends of the second segments are optically coupled to the gate outputs; and
one or more biological probe array substrates disposed to be capable of receiving light passed from the first ends of the second segments to the second ends of the second segments when the addressable gates are in the light-passing state.

43. A system, comprising:
(1) a computer having
(a) a processor, and
(b) a memory unit having stored therein a manufacturing control application that, when executed by the processor, provides gating data; and
(2) an apparatus coupled to the computer, comprising
(a) a plurality of optical transfer elements,
(b) a light beam source that provides a light beam to the optical transfer elements,
(c) a plurality of gates constructed and arranged to selectively switch the optical transfer elements between substantially light-passing and substantially light-not-passing states in response to the gating data, and
(d) one or more biological probe array substrates disposed to be capable of receiving light from the optical transfer elements.

44. The system of claim 43, wherein:
the light beam source includes an ultra-violet radiation source.

45. The system of claim 43, wherein:
the optical transfer elements comprise a single optical fiber, one or more segments of single optical fibers, a bundle of optical fibers, one or more segments of bundles of optical fibers, or one or more optical gates.

46. The system of claim 43, wherein:
one or more of the plurality of optical transfer elements comprises first and second segments, each having an end optically coupled to a gate.

47. The system of claim 43, wherein:
one or more of the gates include a holographic optical element.

48. The system of claim 43, further comprising:
a flow cell constructed and arranged to receive reagents and to dispose the reagents in contact with the substrate.

49. The system of claim 48, wherein:
the substrate is disposed entirely within the flow cell and the flow cell includes a transparent portion constructed and arranged to enable light to reach the substrate.

50. A system, comprising:
(1) a first computer constructed and arranged to process customer orders for synthesized probe arrays to provide probe and array configuration data indicative of at least one probe array sequence;
(2) a second computer, comprising
(a) a processor, and
(b) a memory unit having stored therein (i) a probe array design application that, when executed by the processor, processes the probe and array configuration data to provide probe array design data, and (ii) a manufacturing control application that, when executed by the processor, processes the probe array design data to provide gating data; and
(3) an apparatus coupled to the computer, comprising
(a) a plurality of optical transfer elements,
(b) a light beam source that provides a light beam to the optical transfer elements,
(c) a plurality of gates constructed and arranged to selectively switch the optical transfer elements between substantially light-passing and substantially light-not-passing states in response to the gating data, and
(d) one or more biological probe array substrates disposed to be capable of receiving light from the optical transfer elements.

51. The system of claim 50, wherein:
the first computer receives customer orders over the Internet.

52. A method, comprising the steps of:
(1) processing customer orders for synthesized probe arrays to provide probe and array configuration data indicative of at least one probe array sequence;
(2) processing the probe and array configuration data to provide probe array design data;
(3) processing the probe array design data to provide gating data;
(4) directing a light beam to a plurality of optical transfer elements;
(5) selectively switching the optical transfer elements between substantially light-passing and substantially light-not-passing states in response to the gating data; and
(6) disposing light passed through optical transfer elements in the substantially light-passing state onto the one or more substrates.

53. One or more arrays of biological probes disposed on one or more substrates, wherein the arrays are synthesized by a method comprising the steps of:
(1) directing a light beam to a plurality of optical elements;
(2) selectively switching the optical elements between substantially light-passing and substantially light-not-passing states in response to gating data; and
(3) disposing light passed through optical elements in the substantially light-passing state onto the one or more substrates.

54. The arrays of claim 53, wherein the method further comprises the steps of:
(4) processing customer orders for synthesized probe arrays to provide probe and array configuration data indicative of at least one probe array sequence;
(5) processing the probe and array configuration data to provide probe array design data; and
(6) processing the probe array design data to provide the gating data.
